(19) United States
(12) Patent Application Publication
(10) Pub. No.: US 2003/0033939 A1
(43) Pub. Date: Feb. 20, 2003

(54) Cooking aid

(76) Inventors: Yannick Mahe, Amiens (FR); Ernst Isler-Sieber, Felben-Wellhausen (CH); Markus Froehlich, Zurich (CH)

Correspondence Address: WINSTON & STRAWN, PATENT DEPARTMENT, 1400 L STREET, N.W., WASHINGTON, DC, 20005-3502, US

(21) Appl. No.: 10/229,686

(22) Filed: Aug. 27, 2002

Related U.S. Application Data
(63) Continuation of application No. PCT/EP01/02724, filed on Mar. 12, 2001.

(30) Foreign Application Priority Data
Mar. 29, 2000 (EP) 00106664.6

(51) Int. Cl. A47J 37/10

(52) U.S. Cl. 99/345

(57) ABSTRACT

Cooking aid composed of an envelope based on fat which is solid at room temperature and a fluid or pasty flavoring filling. The envelope of the product according to the invention melts rapidly upon contact with hot food or in a frying pan and possesses good mechanical resistance to handling at room temperature. The envelope comprises of the order of 40 to 100% of fat and up to 60% of filling additives of the polysaccharide, protein or fiber type or a mixture thereof. The aqueous and/or fatty filling of the product according to the invention has a viscosity which is in the range between liquid honey and a pasty spread. Also, a process for the manufacture of such a cooking aid.

### CROSS-REFERENCE TO RELATED APPLICATIONS

This application is a continuation of the US national stage designation of International application PCT/EP01/02724 filed Mar. 12, 2001, the entire content of which is expressly incorporated herein by reference thereto.

### BACKGROUND ART

The present invention relates to a flavoring cooking aid that is capable of being melted or dissolved and intended to be used for the seasoning of cooked foods and/or the cooking or for the preparation of prepared meals. The present invention also relates to a process for manufacturing such a cooking aid.

The cooking aids that are currently available for seasoning/flavoring exist, on the one hand, in the form of liquid or fluid products. However, the problem of portioning exists with this type of product. Moreover, products exist in powdered form which are added directly on the plate or to the dish. However, this type of product is very hygroscopic and requires an appropriate packaging. It also is not easy to portion out or to preserve once opened. The dissolution and the distribution of these pulverulent products is not always easy and results in the formation of lumps.

Ready-portioned cooking aids exist in the form of tablets. The latter are manufactured by the compacting of pulverulent and/or dehydrated ingredients. They must be dissolved in a liquid and this dissolution stage is sometimes long and is not very easy. Some of these stock tablets are intended to be dissolved in rice, pasta and/or vegetable cooking water. Once cooked, the products are drained and practically all the flavorings dissolved in the cooking water are lost. Some cooking aids of the tablet type can also be designed for cooking in a frying pan. However, these tablets exhibit poor melting and need to be crushed. In spite of this, the dispersion of the seasoning is far from being optimum and residual pieces or lumps are often observed, which is particularly unpleasant during consumption. Furthermore, the tablets are manufactured from dehydrated ingredients and it is known that the concentration/dehydration operations are harmful to the organoleptic qualities of the products obtained, most particularly from the flavor point of view. Indeed, the flavor intensity, richness and strength of the dehydrated/concentrated product are far from matching the initial product or a fluid product which is less concentrated.

Flavored butters make it possible to overcome some of these problems, but their shelf life is limited and they have to be stored refrigerated. Moreover, this type of very fatty product constitutes a useful flavor vector only for lipophilic flavors.

Various forms of products of the flavoring capsule type exist; they generally consist of an external coating based on gelatin or alginate or another gelling polymer, which requires prolonged heating in aqueous medium to ensure dissolution and/or rupture of this envelope and release of the contents.

The processes for manufacturing such capsules exploit the coagulating properties of these polymers and the surface tension forces. These capsules are thus produced through the formation of beads or drops in a gelling solution (case of alginates) or a cooling solution (case of gelatin). However, this principle has its limits and the size of the beads formed is limited. In other cases, an empty capsule is formed, in a first instance, by molding two halves, joining them and filling the capsule formed.

JP 10075720 describes a food product composed of a fatty phase and a starchy phase. The fatty phase contains dispersed capsules consisting of a water-soluble envelope containing a flavoring ingredient. When this product is dispersed and heated in a boiling aqueous phase, the water-soluble envelope dissolves and releases the flavoring ingredient. Such a product is intended for the manufacture of roux by adding boiling water.

Various patents describe capsules containing a flavoring composition in powdered, paste, aqueous liquid, oily liquid or emulsion form. In all these cases, the encapsulating material is a gelatin, an alginate, a derivative of these or any other water-soluble gelling or co-gelling polymer: JP 10014554; JP 09313154; DE 29713074; JP 09163963; WO 95/05751; EP 525731; JP 02079941.

Moreover, JP 08010313 describes a capsule-type product containing a liquid filling. This capsule is in the form of a multilayer (3-layer) droplet in which the core is separated from the envelope by a lipophilic layer.

JP 01232963 describes a multilayer soft capsule produced by lamination-molding. The capsule material is chosen so as to have a high resistance to high temperatures, to acids, to bases and to water. Such a product is intended for long preservation of the filling towards external agents.

In view of the preceding, it can be seen that improvements in these type products are desired, and the present invention provides such improvements.

### SUMMARY OF THE INVENTION

The present invention provides a cooking aid which is solid at room temperature and which dissolves rapidly in a boiling liquid or which melts-rapidly upon contact with hot food or with the surface of a hot frying pan.

To this effect, the cooking aid according to the present invention is composed of an envelope based on fat which is solid at room temperature and encloses a fluid or pasty flavoring filling.

The product thus has good mechanical resistance to handling at room temperature and melts rapidly upon contact with food or a kitchen utensil which is hot, which allows rapid dissolution and dispersion of the filling. Also, especially in the case of seasoning cooked pasta, rice or vegetables, the fatty coating melts rapidly, releasing the fluid filling which becomes rapidly distributed in the meat and vegetable dish.

The proportion of the weight of the envelope in the product may be chosen so as to give the product a sufficient mechanical strength to allow easy unmolding and handling. The weight of the envelope may be in a range on the order of 30 to 90% of the final product, for example. Likewise, the fat may have a preferred melting point of between 30 and 60° C.

In the case of the use of the product according to the invention in cooking mode, its properties make it possible to have instant and uniform distribution of the fat and the flavoring ingredients in the frying pan, avoiding the persistence of lumps and of coarse residues. Furthermore, the fluid filling makes it possible to provide novel and different flavor notes of a much better quality compared with the tablets. The flavor profile is richer and more balanced between the top notes and the tail notes. Thus, depending on the carrier for the flavoring ingredients (aqueous or fatty or both), it will be possible to provide a varied range of flavors, of a hydrophilic or lipophilic nature. The flavor profile will be in any case of a much better quality mainly because of the preservation of these top flavor notes since the filling does not undergo dehydration.

### DETAILED DESCRIPTION OF THE PREFERRED EMBODIMENTS

The envelope of the product according to the invention preferably has the following properties: mechanical resistance to handling at room temperature and rapid melting in hot food or on contact with a hot frying pan. The specific formulation of this envelope has thereby allowed, via the selection of fats used as well as of filling additives, to solve these problems. The quantity of fat contained in the envelope may be of the order of 40 to 100%, approximately. The filling additives, which constitute up to 60%, approximately, of the weight of the envelope, may be of a polysaccharide and/or protein and/or fiber and/or salt nature. This may include native starch, chemically and/or physically modified starch, maltodextrin, glucose syrup or a mixture thereof, for example. The polysaccharides added to the fat constituting the envelope may be replaced completely or partially by protein derivatives of the whey protein and/or caseinate type, for example. Dietary fibers of the wheat fiber, methylcellulose or cellulose type, for example, may also form part of these filling additives for the envelope material. Such additives make it possible to increase the viscosity of the envelope material. This is advantageous in the case where the proportion by weight of the envelope relative to the filling in the final product is low.

The fat may be preferably a hydrogenated or fractionated vegetable fat such as hydrogenated palm oil, for example. Animal fat can only be used if it is hydrogenated. The fatty substance, or the mixture of fatty substances used for producing the envelope of the present invention, may have a melting point preferably of between 40 and 55° C. approximately. The viscosity of the mixture of the envelope material may be of the order of 4 to 18 Pa.s, in the region of 10 s⁻¹ and 40° C.

The envelope of the product according to the invention may, in addition, comprise vegetable extracts, particles, spices such as curry, pepper, paprika, for example, colorings, flavorings and/or visual components such as flakes of parsley, garlic, basil, onion, for example and/or vitamins such as riboflavin for example. Moreover, the envelope of the product according to the invention may be partially or completely coated with flakes of dehydrated vegetables or semolina, for example.

The SFC (solid fat content) curve of a fatty substance defines the fraction of fat present in the solid state in the fatty substance as a function of the temperature over a given temperature range, in general 0°-60° C., approximately, for dietary fatty substances. In the present case, the fat used should have a high solids content in the region of room temperature. Furthermore, the SFC curve should decrease rapidly beyond 40° C., approximately, so as to ensure rapid melting during contact with hot foods for consumption. This SFC curve thus advantageously has a biphasic appearance with a low slope between 0° C. and room temperature (20 to 30° C., approximately) and a very high slope over 35° to 45° C., approximately.

These properties thus allow rapid melting of the envelope when the product is added to a hot rice, pasta or vegetable portion just before consumption, while providing good mechanical strength at room temperature.

The unit mass of the product according to the invention may be of about 10-15 g, which allows seasoning of a portion of about 200-300 g of cooked food. The quantity of units of product according to the invention to be added may be adjusted according to the quantity of food to be seasoned.

This rapid melting property of the envelope of the product according to the invention also allows its application as cooking aid in the preparation of prepared meals and dishes. It is thus possible, for example, to add the product according to the invention to a hot frying pan. The envelope melts immediately, the fluid or pasty filling is released and spreads or melts rapidly in the frying pan. It is consequently possible to add meat, fish, vegetables and/or rice, for example, in order to carry out the cooking with or without addition of liquid. In a similar manner, it is possible to add the product according to the invention a few minutes before the end of the cooking of vegetables, meats, fish, rice, prepared meals, sauce dishes.

The envelope of the product according to the invention may also contain, in addition, processed cheese for use for oven-cooking or grating, for example.

The filling/envelope weight ratio in the final product may be in a very broad range, from 70/30 to 10/90, approximately, and preferably 50/50. The value of this ratio is dependent on the size, the shape of the product (sphere, parallelepiped, cylinder portion, bar, heart, cone, truncated cone, or any other molded shape, for example) as well as the viscosity of the filling. The thickness of the envelope will depend on the viscosities of the filling and on the constituent material of the envelope, on the shape, the size and the filling/envelope weight ratio in the product according to the invention. As a guide, the thickness of this envelope may be in the region of 1.5 to 4 mm for a spherical product of 10-15 grams, for example. The finer the envelope, the more rapid its melting and the more rapid the dispersion of the filling.

The filling in the product according to the invention is a fluid or pasty flavoring product whose viscosity may correspond to a range between liquid honey and a pasty spread. It is advantageous to use a particularly fluid product for all the reasons explicitly stated above: rapid dispersion, flavor profile which is more complex and of better quality. However, the filling may be a pumpable pasty product. The filling in the product according to the invention may be based on water, based on fat or an emulsion. This filling may be a concentrated meat and/or vegetable broth of the chicken broth or beef broth type, for example. The filling may be produced according to the mode of manufacture of a reaction flavoring. Such a flavoring is traditionally manufactured by heating a mixture comprising protein or amino derivatives with reducing sugars. Depending on the temperature-duration of treatment pair applied, different flavor profiles are obtained.

The more or less concentrated broth may be added or replaced by a fatty preparation based on olive oil, butter oil, sunflower oil, palm oil, which are more or less hydrogenated. This fatty preparation as well as the broth may be supplemented and/or flavored by addition of flavorings, spices and seasonings such as basil, parsley, garlic, onion, curry, ginger, thyme, fine herbs, chilli, coriander, plant and/or animal food particles or cheese.

In the case of a use of the product according to the invention in prepared meals of the vegetable and/or meat type which are sauteed or in sauce form, the filling may contain one or more thickening ingredients of the native and/or modified starch, guar flour, alginate or maltodextrin type, alone or in the form of mixtures, for example. Thus, during the melting of the envelope, the filling may serve not only as seasoning but also as a binder with the possible addition of liquids such as wine, water, vinegar, cream or milk.

The product according to the invention may be dissolved in a hot liquid for the instant reconstitution of a hot drink, of a broth or of a soup. The product according to the invention has the advantage of being easy to portion out, instantly dissolved without lumps with minimum mechanical force in a hot liquid and also has optimum organoleptic characteristics.

Similarly, the product according to the invention may be melted/dissolved in the base of a frying pan after cooking vegetables and/or meat or in a more or less large quantity of hot or cold liquid, this being in order to produce glazing or a sauce.

The preservation of the product at room temperature may be achieved via the salt content of the filling which may be of the order of 10 to 40% and preferably from 20 to 30%. The salt present in the filling optionally combined with other water activity depressants (humectants) such as polysaccharides, glucose syrups, for example, contributes to reducing the water activity of the product (Aw) which may preferably be in a range of the order of 0.2 to 0.8. In the case where the filling has an Aw greater than 0.8, it will be possible to envisage the use of chemical preservatives, such as sulphites for example, in order to improve the preservation of the product.

The aim of the present invention is also to provide a process for the manufacture of such a cooking aid.

To this effect, the process for the manufacture of the product according to the invention relates to preparing a coextruding envelope and fluid or pasty filling material in a mold so as to entrap the filling inside the envelope material.

In a preferred embodiment of the present process, it is possible to:

heat the envelope material so as to have a pumpable product whose viscosity is greater than or equal to the viscosity of the filling, and

carry out coextrusion of the filling and of the envelope material in a mold so as to envelop the filling inside the envelope material.

The whole combination, once molded-shaped by means of coextrusion in a mold, may be rapidly cooled or left at room temperature, at around 18-24° C., until the envelope becomes firm.

The filling may be produced directly in a mixer by adding pulverulent materials and liquids. The temperature for dosing the mixture may be between 10 and 40° C., approximately, depending on the viscosity of this mixture of pasty fluid. The filling can thus be heated so as to ensure its pumpability.

In parallel, the envelope material of the product according to the invention is manufactured. The fat can thus be mixed at around 50 to 60° C., in a thermostatically maintained ribbon mixer. Polysaccharides and/or protein matter and/or fibers may be optionally added and the mixture may be cooled to a temperature of the order of 25° C. to 40° C. approximately so as to obtain a pumpable, malleable and moldable product.

The two mixtures, fluid or pasty filling on the one hand and envelope material on the other hand, may be coextruded in a mold so as to envelop the filling in the envelope material. The filling may be extruded through a central coextrusion nozzle and the fatty mixture for the envelope through a peripheral nozzle. The injection orifice of the mold can then be blocked by sealing with a film. The whole can then be left as such for cooling to room temperature (18 to 24° C., approximately) or subjected to fast cooling, so as to rapidly harden the envelope material. This cooling may be carried out by passing the molded product through a cooling tunnel at about 2 to 10° C., or by any other means capable of ensuring rapid crystallization of the fat and the solidification of the envelope.

Advantageously, a step may be introduced for removing possible bubbles by application of vibrations between the coextrusion-molding step and the optional sealing step.

The molds used may be metallic or plastic molds, for example. In the case of the use of reusable metallic molds, the product may be unmolded after the cooling step and packaged in cases, blister packs or boxes, for example, or any other packaging capable of protecting the product. A blister back is a packaging consisting of one or more plastic shells, optionally sealed, glued to a carton base or plastic support. Such a packaging is intended to present and protect small-sized merchandise. The non-recyclable molds can serve as primary packaging, the product is then provided in a sealed blister-type packaging. The blister pack can then be placed in a case in order to improve the protection of the product and allow information relating to the product to be written on. In this embodiment, the consumer can open the blister pack at the time the product according to the invention is used.

The molds used for shaping the product according to the invention may have any type of shape: sphere, cube, parallelepiped, cone, heart, bar, various animals and persons. The sizes and proportions of the product according to the invention will depend on the flavoring power and/or the binding effect required. The volume of the product according to the invention may be within a range on the order of 8 to 25 cm³. Theoretically, there is no limit regarding the sizes of the product according to the invention. The products according to the invention can be preserved at room temperature over periods of up to 12 or even 18 months.

### EXAMPLES

The following examples make it possible to illustrate a few variants of the product and different embodiments for using the product according to the invention.

### Example 1

### Chicken Stock

Production of the envelope material: A material constituting the envelope is prepared which has the following composition:

| | | |
|---|---|---|
| Partially hydrogenated/fractionated palm oil | 1.5 | kg |
| Chopped parsley (flakes) | 2 | g |
| Vitamin B2 | 0.5 | g |
| Paprika powder | 1.7 | g |
| Maltodextrin | 560 | g |

To prepare this material, the fat is heated to 55-60° C. and introduced into a jacketed ribbon mixer. The other ingredients are then added and mixed.

The mixture is then cooled in the mixer by means of the jacket whose temperature is set at 30° C. At the end of this step, the mixture is easily pumpable and malleable and has a relatively viscous texture. Its temperature is then 30° C. approximately. It is then transferred to a buffer tank kept at the same temperature.

Production of the filling: The filling consists of a reaction flavoring prepared as follows. The following ingredients are mixed in a reactor and heated for 90 min at 98° C.:

| | | |
|---|---|---|
| Salt | 750 | g |
| Water | 1 250 | kg |
| Granulated sugar | 315 | g |
| Maltodextrin | 316 | g |
| Powdered chicken meat | 72 | g |
| Powdered yeast extract | 72 | g |
| Sodium inosinate | 21 | g |
| Fried onion flavor | 16 | g |
| L-Cysteine | 12 | g |
| Turmeric | 16 | g |
| Rosemary | 3.15 | g |
| Diammonium phosphate | 7 | g |
| Pepper | 3 | g |
| Chicken flavor | 3.5 | g |
| Cassava starch | 87 | g |
| Keltrol alginate | 5.5 | g |

After the reaction, the mixture is cooled to room temperature. The preparation of this mixture may be carried out beforehand. The mixture may be measured out at room temperature. It is transferred to a non-heated buffer tank.

The mixtures are transferred to the corresponding hoppers of an Awema UDM 202/96 measuring device (AWEMA AG, ZURICH) via thermostatically maintained pumps. The temperature of these hoppers is also maintained so as to maintain a constant viscosity, that is 30° C. for the envelope material and 25° C. for the filling.

The mixtures are directly injected and measured out by coextrusion via double measuring nozzles (diameter of the inner nozzle 7.6 mm, diameter of the outer nozzle 9 mm) into molds comprising 20 to 120 PET (Polyethylene Terephthalate) cells having a parallelepipedal shape. The pistons measuring out the products distribute the filling and the envelope material in a proportion of 50/50. The total mass delivered is about 12 g. A film is then sealed over the molds by heating.

The molds are then cut so as to have sheets of 4 to 10 blisters.

The product is then cooled in a cooling tunnel at 5° C., for about 10 minutes, so as to ensure rapid solidification of the envelope material.

The sheets of 4 to 10 blisters are then packaged in carton cases.

Use: The cooking aid thus obtained can serve for reconstituting a chicken stock. 200 g of boiling water are added to a cube thus obtained of the product according to the invention. The envelope melts rapidly and releases the fluid filling which becomes easily diluted in the hot water. A chicken stock is thus easily and rapidly obtained which has the flavor characteristics of a freshly prepared stock.

### Example 2

### “Al Pesto” Seasoning For Pasta

The method of producing the product according to the invention is identical to that described in Example 1 except with regard to the specific ingredients, the preparation of the mixture corresponding to the filling and the envelope/filling proportion in the final product which is, in this case, 42/58.

The following ingredients are used for the manufacture of the envelope material:

| | | |
|---|---|---|
| Partially hydrogenated/fractionated palm oil | 750 | g |
| Partially hydrogenated palm oil | 740 | g |
| Maltodextrin | 520 | g |
| Powdered spinach | 52 | g |
| Parsley flakes | 21 | g |

Ingredients for the Filling:

| | | |
|---|---|---|
| Powdered cheese | 233 | g |
| Salt | 990 | g |
| Parsley | 90 | g |
| Basil | 58 | g |
| Garlic powder | 116 | g |
| Cheese flavor | 88 | g |
| Powdered onion | 58 | g |
| Powdered spinach | 58 | g |
| Basil flavor | 26 | g |
| Butter oil | 620 | g |
| Olive oil | 585 | g |

The mixture corresponding to the filling is prepared in a ribbon mixer, the fat is introduced at 55° C. approximately, the other ingredients being at room temperature. The homogenized mixture is then cooled to a temperature of about 30° C. Here, the product is coextruded in a manner identical to what is explained in Example 1 in blisters having the shape of a cylinder section.

Use: The cooking aid thus prepared may be used for seasoning and flavoring pasta. Pasta of the tagliatelle type is cooked in unsalted boiling water in a traditional manner. Once cooked, the pasta is drained, and poured onto a dish or a plate. The cooking aid according to the invention is added to the hot pasta in an amount of 1 article (about 12 g) per 220 g of pasta. Upon contact with the hot pasta, the product envelope as well as the fatty filling melt within the dish. A simple mixing makes it possible to easily and rapidly distribute the seasoning within the cooked pasta.

### Example 3

### Thyme/Lemon Cube for a Preparation for Frying

The method of preparing a product according to the invention is identical to that described in Example 1 except as regards the ingredients. Here, the product is coextruded in blisters having a parallelepipedal shape.

Ingredients for the Filling:

| | | |
|---|---|---|
| Salt | 495 | g |
| Fried onion flavor | 75 | g |
| Powdered thyme | 17.5 | g |
| Lemon-lime | 17.5 | g |
| Paprika powder | 7.5 | g |
| Powdered bay leaves | 5 | g |
| Pepper | 2.5 | g |
| Butter oil | 1.9 | kg |

Ingredients for the Envelope:

| | | |
|---|---|---|
| Partially hydrogenated/fractionated palm oil | 937 | g |
| Partially hydrogenated palm oil | 937 | g |
| (45-46° C., melting point) | | |
| Corn starch | 600 | g |
| Curry powder | 12.5 | g |
| Sweet paprika | 12.5 | g |

Use: A cooking aid (about 12 g) thus obtained is placed in a hot frying pan; the envelope melts immediately and thus releases the fatty flavoring filling which in turn melts. About 150 g of thinly sliced chicken are added and thus fried in the mixture until the meat is cooked.

What is claimed is:

1. A cooking aid composed of an envelope based on fat which is solid at room temperature which encloses a fluid or pasty flavoring filling.

2. The cooking aid according to claim 1, wherein the envelope has a fat content of between 40 and 100% by weight, and comprises up to 60% by weight of one or more of polysaccharides, proteins, fibers, or salt.

3. The cooking aid according to claim 2, wherein the envelope has fat content of between 60 and 80% by weight and between 40 and 20% by weight of one or more of polysaccharides, proteins, fibers, or salt.

4. The cooking aid according to claim 1, wherein the envelope fat has a melting range of between 30 and 60° C.

5. The cooking aid according to claim 1, wherein the filling and envelope are present in the final product in a weight ratio of from 70/30 to 10/90.

6. The cooking aid according to claim 1, wherein the filling has an aqueous or fatty base.

7. The cooking aid according to claim 1, wherein the filling contains food particles or thickening agents.

8. The cooking aid according to claim 1, further comprising food particles in or upon the envelope.

9. The cooking aid according to claim 1, wherein the filling comprises salt in an amount of 10 to 40% of the weight of the filling.

10. The cooking aid according to claim 1, wherein the water activity of the filling is between 0.2 and 0.8.

11. A process for the manufacture of a cooking aid comprising the following steps:
providing envelope and filling materials,
heating the envelope material so as to have a pumpable product whose viscosity is greater than or equal to that of the filling, and
carrying out coextrusion of the filling and envelope materials so that filling is provided inside the envelope material,
wherein the envelope is based on a fat which is solid at room temperature, the filling is a fluid or pasty flavoring filling, and the envelope encloses the filling.

12. The process according to claim 11, wherein the filling material is heated to provide a desired flavor profile.

13. The process according to claim 11, wherein the molded product is subjected to a forced cooling to seal the filling material inside the envelope.

14. The process according to claim 11, wherein the coextrusion of the filling and envelope materials is carried out in a mold.

15. The process according to claim 11, which further comprises including food particles in or upon the envelope.
